(19) United States
(12) Patent Application Publication
(10) Pub. No.: US 2026/0034590 A1
(43) Pub. Date: Feb. 5, 2026

(54) Cutout-Plug-Easy-Release Hole Saw

(71) Applicant: Zhong Liu, Crestwood, KY (US)

(72) Inventor: Zhong Liu, Crestwood, KY (US)

(21) Appl. No.: 18/793,387

(22) Filed: Aug. 2, 2024

(51) Int. Cl. B23B 51/04

(52) U.S. Cl. CPC B23B 51/0413; B23B 51/0426

(57) ABSTRACT

This invention is an improvement to the hole-cutting saw that is currently widely available in the market. A tiny cutting blade attached to the bottom inner wall of the hole saw to help shave out diameter of the cutout plug, and cone shaped pilot drill bit to reduce the friction between cutout plug and pilot drill bit. End result is the quick, easy separation of cutout plug from hole saw.

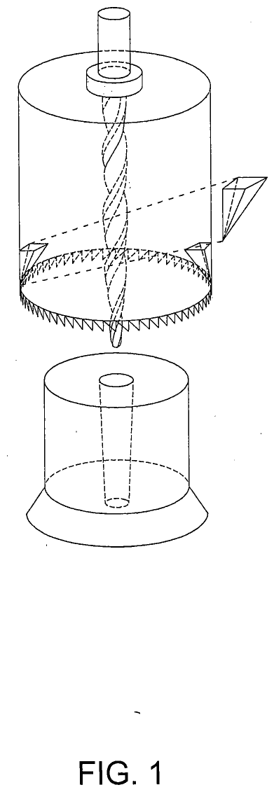

### CROSS-REFERENCE TO RELATED APPLICATIONS

This is the same invention as my previously filed application 62/582,286, filed on Nov. 6, 2017, which was never properly finished and abandoned. I am filing a new application now, and will finish it up.

### BACKGROUND OF THE INVENTION

The round hole saws we see in the market mostly are straight cylinder shaped, with saw teeth on the rim of the cylinder, and a straight cylinder-shaped pilot drill bit in the center of the saw for anchoring the cut.

As a result of this design, the cut-out plug is cut to the exact shape of the inside of the circular saw cylinder, and in very tight contact with the inside wall of the saw cylinder, make it hard to release the cutout plug.

Also, since the pilot drill bit is straight cylinder shaped, the inner surface of the pilot hole within the cutout plug is also in close contact with the pilot drill bit. Make the release of the cutout plug even harder.

User normally will have to take additional steps to push the cut-out plug out from a hole at the bottom of the saw, or pry out the plug from opening slots located on the cylinder wall of the hole saw. It's a time-consuming, cumbersome and frustrating task for the tool users.

The Invention here will remove the surface contacts between the cut-out plug and the inside wall of the saw cylinder, as well as reduce the close surface contact between pilot drill bit and the pilot hole inside surface. It will make the release of the cut-out material almost instantly. The cut-out plug can drop out of the saw immediately on its own weight.

### SUMMARY OF THE INVENTION

This invention is an improvement to the hole-cutting saw that is currently widely available in the market. A tiny cutting blade attached to the bottom inner wall of the hole saw to help shave out diameter of the cutout plug, and cone shaped pilot drill bit to reduce the friction between cutout plug and pilot drill bit. End result is the quick, easy separation of cutout plug from hole saw.

### BRIEF DESCRIPTION OF DRAWINGS

On the drawing there is a hole saw, with triangular wedge-shaped blade attached to the bottom inner wall of the saw, an expansion of the triangular wedge-shaped cutting blade, and a sample cutout plug which shaped by the cutting blade.

### DETAILED DESCRIPTION OF THE INVENTION

This invention targets improvements to the hole-cutting saw that is currently widely available in the market. With a small cutting blade attached to the bottom inner wall of the hole saw cylinder to help shave out the contact between cutout plug and inner cylinder wall of the saw. Also, use of a cone shaped pilot drill bit to replace the current straight cylinder-shaped pilot drill bit, to reduce the release friction between the cutout plug and the pilot bit. Invention will make the release of the cut-out plug inside the saw cylinder extremely easy and get the saw ready for next cut job in no time.

1. A circular saw with triangular shaped cutting blade bit on the inner wall of the circular saw cylinder, right at the bottom of the hole saw's teeth line.

2. A cone shaped pilot drill bit.
